(19) United States
(12) Patent Application Publication
(10) Pub. No.: US 2018/0290939 A1
(43) Pub. Date: Oct. 11, 2018

(54) A SLOW RELEASE FERTILIZER DEVICE

(71) Applicant: PLANT SAFE GLOBAL SDN BHD, SELANGOR (MY)

(72) Inventor: KIM FUI NG, SHAH ALAM (MY)

(21) Appl. No.: 15/762,922

(22) PCT Filed: Feb. 29, 2016
(86) PCT No.: PCT/MY2016/050011

§ 371 Date: Mar. 23, 2018

(30) Foreign Application Priority Data
Jul. 24, 2015 (MY) PI2015702427

(51) Int. Cl. C05D 9/00; B65D 65/46; C05F 11/08; C05G 3/00; A01C 21/00

(52) U.S. Cl. CPC C05D 9/00; B65D 65/466; A01C 21/00; C05G 3/00; C05F 11/08

(57) ABSTRACT

The present invention provides a fertilizing device having a permeable package for fertilizer and a method for slowly releasing fertilizer by placing the fertilizing device in or onto the soil in the vicinity of the plants or the crops. The permeable package is enclosed with a layer for protecting the package and preventing unintended release of fertilizer from the permeable package.

### FIELD OF INVENTION

The present invention relates to a device for holding and releasing a fertilizer.

### BACKGROUND OF THE INVENTION

The present invention relates more particularly to a fertilizing device using permeable membrane that allows the exchange of moisture from the external environment to release the fertilizer nutrients that are within the device wherein the fertilizer is to be released in a gradual manner.

The device of the present invention prevents wastage of both organic and inorganic fertilizers from surface run off and leaching due to rainfall by withholding or containing the fertilizer within the device. It is a device that is focused on the life cycle the fertilizer that covers manuring, nutrient enriching, soil conditioning, cultivating, and yield enhancing.

The existing fertilizer packages with perforations are not fully compatible with organic fertilizers, mineral fertilizers and living organic microbes. It is observed that this kind of fertilizer packages which are made of impermeable material do not efficiently release the fertilizer as particles from organic matter often get stuck in or around the perforated openings and clog the openings during moistening and drying phases. To avoid this problem, the existing fertilizer packages may not be packed without organic matter. However, the absence of organic matter within the package means no microbes will be able to survive. Mineral fertilizers require microbes to break down the nutrient contents, thus making the packaging of the existing fertilizer packages inefficient when used for organic fertilizers, mineral fertilizers and contents with living organic microbes.

The existing fertilizer packages also take a longer time to begin its release of nutrients as the humidity/moisture from the surrounding has a much smaller percentage allowance to enter through the perforations as compared to the permeable membrane structured material.

It would therefore be desirable to provide a fertilizing device that is compatible with organic fertilizers, mineral fertilizers and contents with living organic microbes in which the device can prevent clogging caused by the moistening and drying of organic matters that are packed within the device. The present invention allows a more natural flow of moisture through the device allowing for better interaction between the contents i.e. fertilizer, microbes, enzymes, and etc. with the soil it is placed on. The present invention allows air humidity to be absorbed into the device much more easily thus allowing the device to work better in a drier environment. Furthermore, as there are living organisms like microbes within most soil types, the present invention then allows better interaction with the organisms within the soil allowing better activity of nutrient breakdown and carbon recycling.

### SUMMARY OF THE INVENTION

The present invention provides a fertilizing device comprising a package for holding and releasing a fertilizer characterised in that the package is composed of permeable membrane or any permeable membrane structured materials or porous linings wherein the permeability of the membrane or material or linings allows moisture to enter into the device either by physical penetration or isotonic absorption of the chemical salts within the fertilizer content, which will then dissolve the fertilizer within and the gravitational pull will excrete the dissolved fertilizer out in a controlled release rate in accordance to the permeability level.

Preferably, the permeable membrane is in the form of a flexible woven material or fabric consisting of a network of natural or artificial fibres often referred to yams which have a plurality of long strands. Optionally, the permeable membrane is substantially biodegradable. For instance, the air permeability of the material can range between 10 l/dm²/min to 3000 l/dm²/min to allow limited sized particles of the moisture dissolved fertilizer to escape freely through the yams or strands without clogging up.

In one embodiment, the permeable package is enclosed with a layer with no perforations or no permeability for protecting the permeable package and preventing any unintended release or escape of fertilizer content or nutrients from the permeable package. Optionally, the protective layer is substantially biodegradable.

In another embodiment, a detection device can be added to the present invention to allow remote auditing through satellite detection or manual detection. This is to ensure correct application of the fertilizing device has been made on the site and also allows for theft detection.

### BRIEF DESCRIPTION OF THE DRAWINGS

The present invention will be described by way example only, with reference to the accompanying drawings, in which:

FIG. 1 shows an example of a permeable package for holding and releasing fertilizer enclosed with aprotective layer;

FIG. 2 shows an interaction between the external moisture and the fertilizer inside the permeable package shown in FIG. 1; and

FIG. 3 shows a release of fertilizer from the permeable package shown in FIG. 1 and FIG. 2.

### DETAILED DESCRIPTION OF THE INVENTION

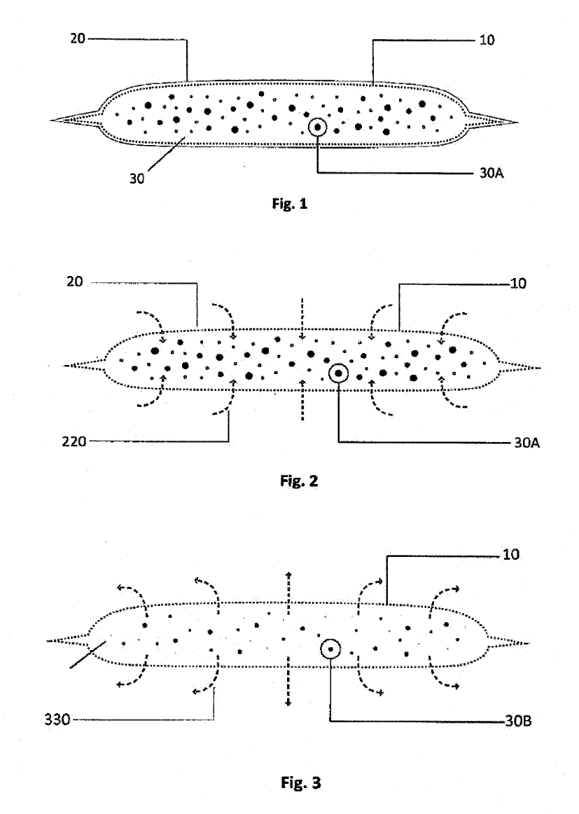

Referring to FIG. 1, the fertilizing device comprises a permeable package wherein the permeable package (10) is enclosed with a protective layer (20). It is to be noted that the enclosure of the protective layer is optional. The permeable package holds a fertilizer (30A) of any one or any combination of organic fertilizer, inorganic fertilizers, microbes, enzymes, yield enhancers, etc. The package (10) is composed of permeable membrane or any permeable membrane structured materials or porous linings which include a flexible woven material or fabric consisting of a network of natural or artificial fibres often referred to as yarns having a plurality of long strands.

Optionally, the permeable package and/or the protective layer are biodegradable. For instance, a polylactic acid (PLA), which is a biodegradable polymer, can be used for the manufacture of the package with the air permeability of the fabric made from the polylactic acid is about 800l/dm²/min.

FIG. 2 shows a situation when the protective layer (20) has been degraded (shown as dotted line). The degradation of the protective layer exposes the permeable package (10) wherein the interaction between the environments i.e. soil and/or air and the nutrients inside the permeable package occurs. External moisture (220), shown by multiple inward arrows) will enter the package through the permeable membrane and the nutrients begin to dissolve into the moisture. Without the interaction, the nutrients will not be dissolved and thus the particles of the fertilizer will not be released from the package. The permeable membrane allows a controlled release of the fertilizer. As shown in FIG. 3, the dissolved nutrients i.e. the fertilizer will be released (330), shown by multiple outward arrows) in gradual manner in accordance to the permeability rate of the permeable membrane. As shown in FIG. 3, the dissolved nutrients have become smaller particles (30B) compared to the particles of undissolved nutrients (30A) shown in FIGS. 1 and 2. As the size of the particles become smaller, the soluble fertilizer will escape freely through the yarns or strands of the preamble membrane without being clogged. After some time, the quantity of the fertilizer inside the permeable package will reduce and the package will degrade.

In another embodiment, the fertilizing device includes a marker which is capable of identifying the details of the fertilizing device such as its date of manufacture, contents, date of placement on the soil as well as allowing the location of the fertilizing device to be detected manually or remotely. Preferably, the marker is in the form of an electronic device or chip that can be detected or communicate with i.e. provide said details or information. The marker is attached to the fertilizing device or included within the fertilizing device. For instance, the detection or monitoring of the marker or the fertilizing device is performed through a Global Positioning System (GPS).

The present invention also provides a method for slowly releasing fertilizer by placing the fertilizing device having a permeable package enclosed with or without protective layer in or onto the soil in the vicinity of the plants or the crops. The use of the present invention will prevent human direct contact to the inorganic fertilizers. The controlled release of the fertilizer from the permeable package within the vicinity of the plants or the crops allows the dissolved fertilizer to be supplied directly to the crops and prevent the dissolved fertilizer from polluting unintended areas such as river.

1.-13. (canceled)

14. A fertilizing device, comprising:
a package for holding and releasing a fertilizer;
wherein the package is comprised of a permeable membrane in the form of a flexible woven material consisting of a network of natural or artificial fibers or yarns having a plurality of long strands, having an air permeability between 10 l/dm²/min to 3000 l/dm²/min, so that any dissolved fertilizer is released at a desired rate according to the air permeability without clogging up.

15. The fertilizing device as claimed in claim 14, wherein the package is enclosed with a layer for protecting the package and preventing unintended release of the fertilizer from the package.

16. The fertilizing device as claimed in claim 14, wherein the permeable membrane is comprised of biodegradable polymer.

17. The fertilizing device as claimed in claim 16, wherein the biodegradable polymer is polylactic acid (PLA).

18. The fertilizing device as claimed in claim 14, wherein the permeable membrane has an air permeability of about 800 l/dm²/min.

19. The fertilizing device as claimed in claim 14, wherein the package is biodegradable.

20. The fertilizing device as claimed in claim 15, wherein the protective layer is biodegradable.

21. The fertilizing device as claimed in claim 14, wherein the fertilizer is of any one or a combination of organic fertilizers, inorganic fertilizers, microbes, enzymes, and yield enhancers.

22. The fertilizing device as claimed in claim 14, wherein a marker is attached on or included within the device and is capable of identifying details of the fertilizing device including its date of manufacturer, contents, date of placement on the soil and allowing a location of the fertilizer device to be detected manually or remotely

23. The fertilizing device as claimed in claim 22, wherein the detection of the location is through a global positing system (GPS)

24. A method for slowly releasing fertilizer, comprising the step of placing a fertilizing device as in claim 14, in or onto soil in a vicinity of plants or crops.
